(19) United States
(12) Patent Application Publication
(10) Pub. No.: US 2011/0203744 A1
(43) Pub. Date: Aug. 25, 2011

(54) Venetian Blind

(76) Inventor: Ya-Fen Lee, Hsinchu City (TW)

(21) Appl. No.: 12/710,197

(22) Filed: Feb. 22, 2010

(51) Int. Cl. E06B 9/322

(52) U.S. Cl. 160/172 R

(57) ABSTRACT

An adjustable Venetian blind includes head and bottom rail units and a slat unit. The head rail unit includes a first head rail having an engaging end, a second head rail connected telescopically to the engaging end, and a positioning member locking releasably the first head rail to the second head rail. The slat unit has a plurality of horizontal slats interconnected by first and second ladder cords. Each of the slats includes a first slat segment and a second slat segment having an end portion superposed on an end portion of the first slat segment. The bottom rail unit has a first bottom rail and a second bottom rail connected telescopically to the first bottom rail.

### BACKGROUND OF THE INVENTION

1. Field of the Invention

The invention relates to a Venetian blind, more particularly to a width-adjustable Venetian blind.

2. Description of the Related Art

Referring to FIGS. 1 and 2, a conventional width-adjustable Venetian blind 100 is shown to comprise a head rail unit 11 extending along a horizontal direction (X), a bottom rail unit 12 extending along the horizontal direction (X), and a plurality of horizontal slats 13.

The head rail unit 11 has a first head rail 111, a second head rail 112, and a third head rail 113. The first head rail 111 and the third head rail 113 are connected telescopically and respectively to two opposite ends of the second head rail 112, and are movable relative to the second head rail 112 in the horizontal direction (X). The total length of the head rail unit 11 is adjusted by moving the first and the third head rails 111, 113 relative to the second head rail 112.

The bottom rail unit 12 has a first bottom rail 121, a second bottom rail 122, and a third bottom rail 123. The first bottom rail 121 and the third bottom rail 123 are connected telescopically and respectively to two opposite ends of the second bottom rail 122, and are movable relative to the second head rail 112 in the horizontal direction (X). The total length of the bottom rail unit 12 is adjusted by moving the first and the third bottom rails 121, 123 relative to the second bottom rail 122.

Each of the slats 13 has a first slat segment 131 disposed under the first and second head rails 111, 112 and a second slat segment 132 disposed under the third head rail 113. The length of each of the head and bottom rail units 11, 12 and the slats 13 is adjustable, such that the width of the Venetian blind 100 is adjustable.

However, each of the first and third head rails 111, 113 and first and third bottom rails 121, 123 has a predetermined insertion length that is the maximum length inserted into the corresponding one of the second head and bottom rails 112, 122. When the desired adjustment length is between one predetermined insertion length and two predetermined insertion lengths, it is required to adjust the first and third head rails 111, 113 relative to the second head rail 112, and the first and third bottom rails 121, 123 relative to the second bottom rail 122, which is inconvenient to conduct.

Further, each of the head and bottom rail units 11, 12 is comprised of three segments, which results in a troublesome manufacturing process and an increase in the manufacturing costs of the Venetian blind 100.

### SUMMARY OF THE INVENTION

Therefore, the object of the invention is to provide a Venetian blind capable of alleviating the above drawbacks of the prior art.

Accordingly, an adjustable Venetian blind of the present invention comprises a head rail unit, a slat unit, and a bottom rail unit. The head rail unit extends along a horizontal direction, and includes a first head rail having an engaging end, a second head rail connected telescopically to the engaging end of the first head rail, and a positioning member locking releasably the first head rail to the second head rail. The slat unit has two first ladder cords, a second ladder cord, a plurality of horizontal slats, and first and second lift cords. The first ladder cords are suspended respectively from two opposite ends of the first head rail. The second ladder cord is suspended from the second head rail. The slats are vertically spaced apart from each other and are interconnected by the first and second ladder cords. The first and second lift cords are hung respectively under the first head rail and the second head rail, and are disposed for lifting the slats. Each of the slats includes a first slat segment connected to the first ladder cords, and a second slat segment connected to the second ladder cord and having an end portion superposed on an end portion of the first slat segment. The bottom rail unit has a first bottom rail fastened to bottom ends of the first ladder cords, and a second bottom rail connected telescopically to the first bottom rail and fastened to a bottom end of the second ladder cord.

### BRIEF DESCRIPTION OF THE DRAWINGS

Other features and advantages of the invention will become apparent in the following detailed description of the preferred embodiments with reference to the accompanying drawings, of which:

FIG. 1 is a front view of a conventional Venetian blind;

FIG. 2 is a perspective view of the conventional Venetian blind;

FIG. 3 is a perspective view of a first preferred embodiment of a Venetian blind according to the present invention;

FIG. 4 is a partly exploded perspective view of the first preferred embodiment;

FIG. 5 is a fragmentary schematic sectional view of the first preferred embodiment;

FIG. 6 is a perspective view of the first preferred embodiment, illustrating a width of the Venetian blind after adjustment;

FIG. 7 is a perspective view of a second preferred embodiment of a Venetian blind according to the present invention; and

FIG. 8 is a partly exploded perspective view of the second preferred embodiment.

### DETAILED DESCRIPTION OF THE PREFERRED EMBODIMENTS

Before the invention is described in greater detail with reference to the accompanying embodiments, it should be noted herein that like elements are denoted by the same reference numerals throughout the disclosure.

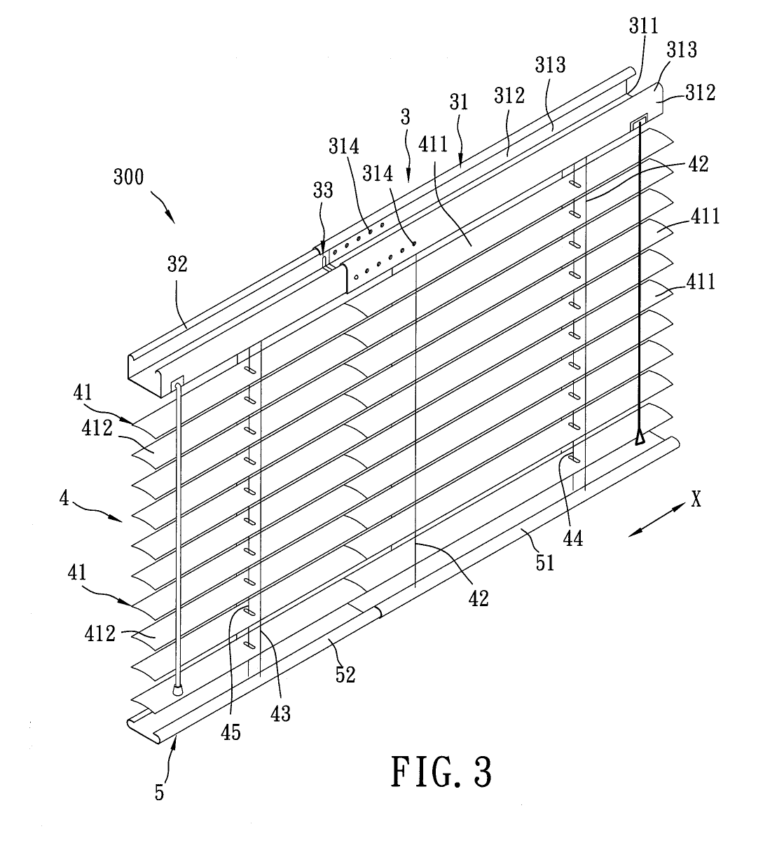

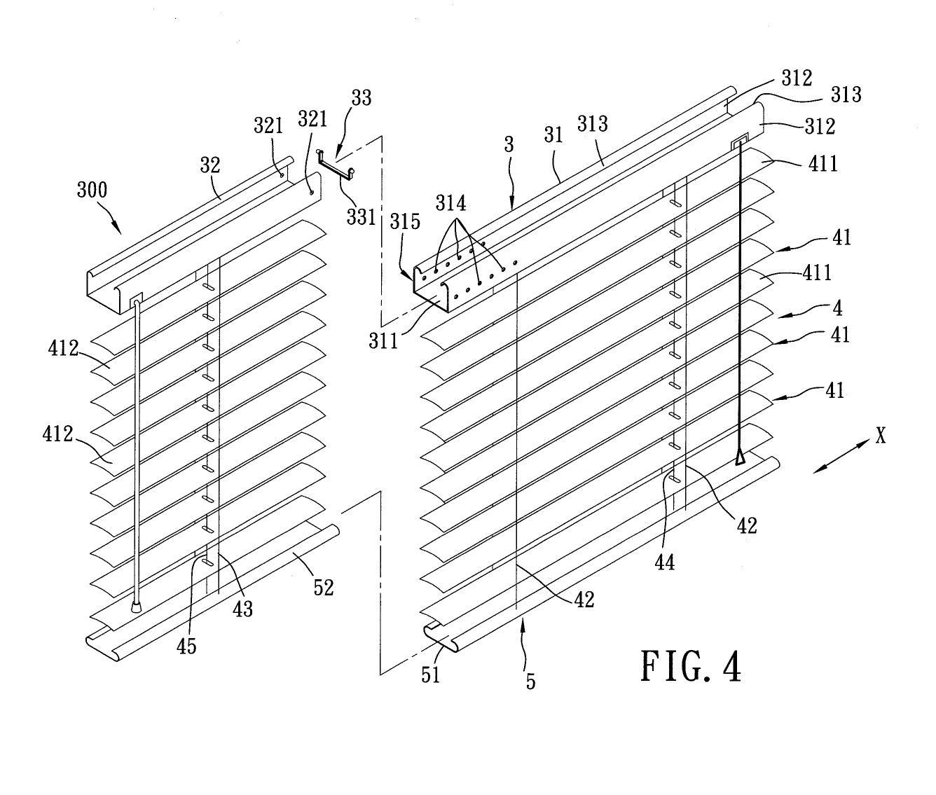

Referring to FIGS. 3 to 6, a first preferred embodiment of an adjustable Venetian blind 300 according to the present invention comprises a head rail unit 3, a slat unit 4, and a bottom rail unit 5. The head rail unit 3 extends along a horizontal direction (X), and has a first head rail 31, a second head rail 32, and a positioning member 33. The first head rail 31 has an engaging end 315, a base rail wall 311 extending along the horizontal direction (X), two side rail walls 312 extending respectively and upwardly from two opposite sides of the base rail wall 311, and two guiding walls 313 each extending from an upper end of a respective one of the side rail walls 312 toward the other one of the side rail walls 312 and having a hook-shaped cross-section. Each of the side rail walls 312 is formed with a horizontal row of spaced apart outer positioning holes 314 that are formed in the engaging end 315 of the first head rail 312.

The second head rail 32 is connected telescopically to the engaging end 315 of the first head rail 31 in such a manner that it extends into a space among the base rail wall 311, the side rail walls 312, and the guiding walls 313, and is movable relative to the first head rail 31 in the horizontal direction (X). In this preferred embodiment, the second head rail 32 is formed with two inner positioning holes 321.

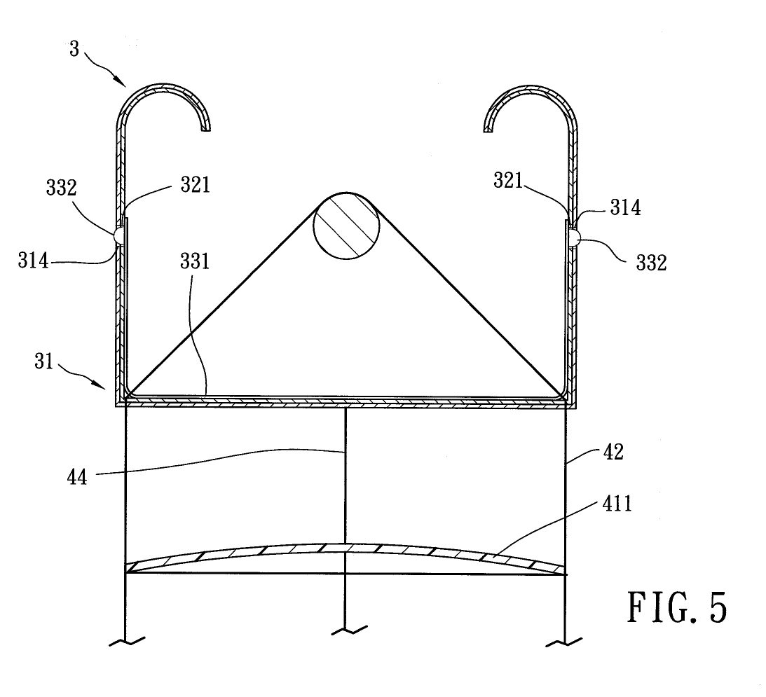

The positioning member 33 is for locking releasably the first head rail 31 to the second head rail 32 and extends through the inner positioning holes 321 and two selected ones of the outer positioning holes 314. In this preferred embodiment, the positioning member 33 includes a spring plate 331 that is disposed in the second head rail 32 and that has a U-shaped cross-section, and two protrusions 332 (shown in FIG. 5) extending respectively from two ends of the spring plate 331 and through the inner positioning holes 321 and the selected ones of the outer positioning holes 314. In this preferred embodiment, the first head rail 31 is longer than the second head rail 32.

The slat unit 4 has two first ladder cords 42, a second ladder cord 43, a plurality of horizontal slats 41, and first and second lift cords 44, 45. The first ladder cords 42 are suspended respectively from two opposite ends of the first head rail 31. The second ladder cord 43 is suspended from the second head rail 32. The slats 41 are vertically spaced apart from each other, and are interconnected by the first and second ladder cords 42, 43. Each of the slats 41 has a first slat segment 411 that is connected to the first ladder cords 42, and a second slat segment 412 that is connected to the second ladder cord 43 and that has an end portion superposed on an end portion of the first slat segment 411. The first and second ladder cords 42, 43 can be operated to adjust the tilt angle of the slats 41 in a known manner.

The first and second lift cords 44, 45 are hung respectively under the first head rail 31 and the second head rail 32, and are disposed for lifting the slats 41. When the user pulls the first and second lift cords 44, 45, the bottom rail unit 5 is lifted up. In this preferred embodiment, the first slat segments 411 are longer than the second slat segments 412.

The bottom rail unit 5 has a first bottom rail 51 fastened to bottom ends of the first ladder cords 42, and a second bottom rail 52 fastened to a bottom end of the second ladder cord 43. In this preferred embodiment, each of the first and second bottom rails 51, 52 has a C-shaped cross-section such that the second bottom rail 52 is connected telescopically to the first bottom rail 51 and is movable relative to the first bottom rail 31 in the horizontal direction (X). The first bottom rail 51 is longer than the second bottom rail 52.

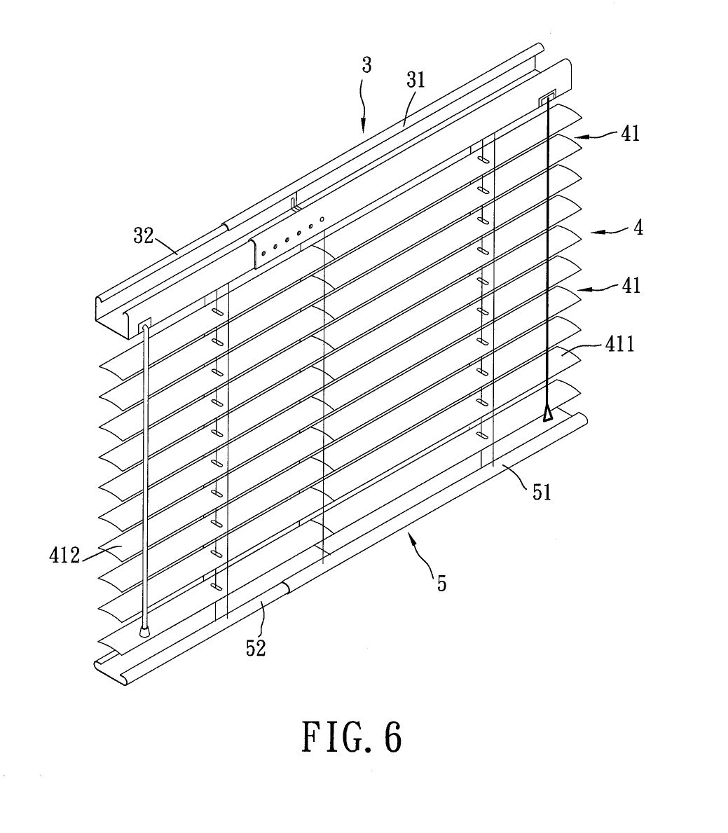

Therefore, when it is desired to adjust the width of the Venetian blind 300, the user presses the protrusions 332 into the inner positioning holes 321, respectively, to allow the first head rail 31 to be moved relative to the second head rail 32 in the horizontal direction (X). After the first head rail 31 is adjusted to a desired position relative to the second head rail 32, the protrusions 332 are biased by the spring plate 331 to engage the two of the outer positioning holes 314 corresponding to the desired position, thereby maintaining the first head rail 31 at the desired position. As a result, the length of the head rail unit 3 is changed. During the length changing process, relative movement of the first and second head rails 31, 32 results in relative movement of the first and second slat segments 411, 412 and of the first and second bottom rails 41, 42. In this manner, the width of the Venetian blind 300 may be shortened as shown in FIG. 6.

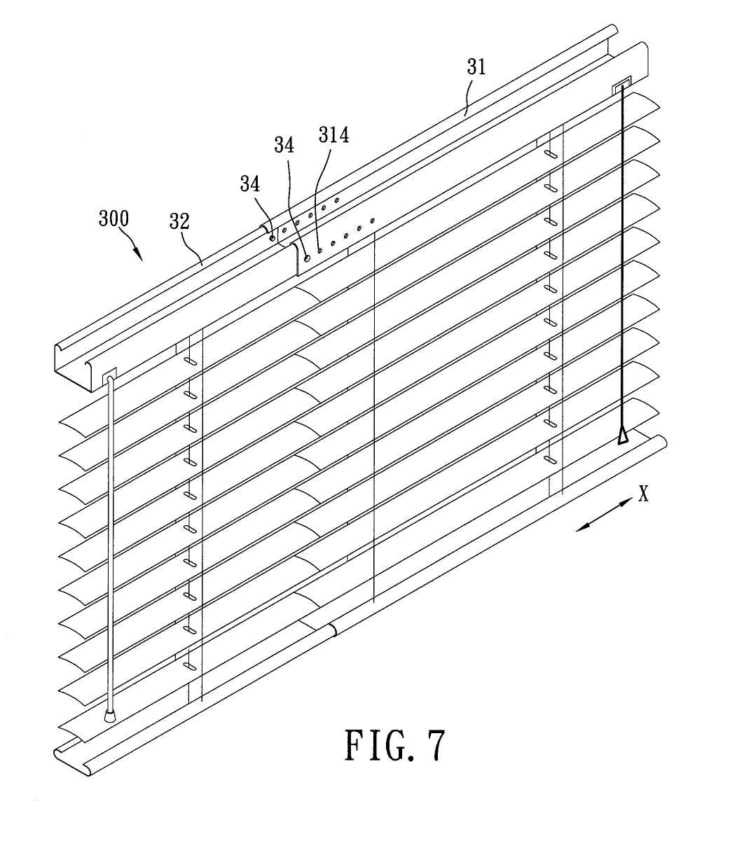

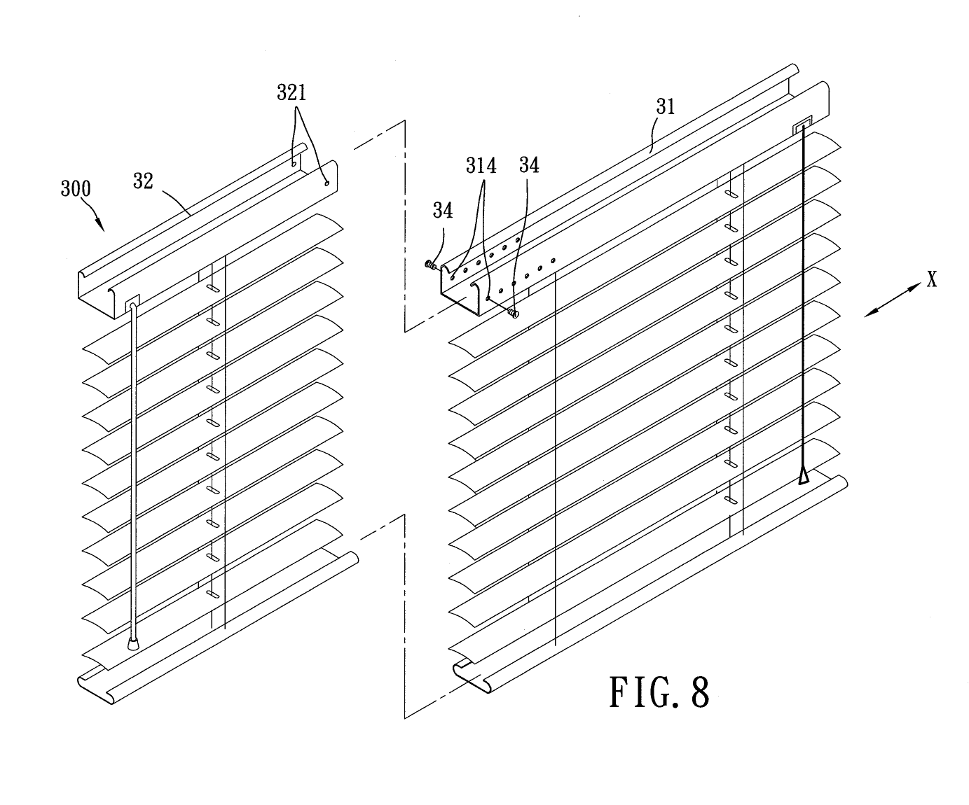

Referring to FIGS. 7 and 8, a second preferred embodiment of the adjustable Venetian blind 300 according to the present invention has a structure similar to that of the first embodiment. The main difference between this embodiment and the first embodiment resides in the configuration of the positioning member 34. In the second preferred embodiment, the positioning member 34 is in a form of two screws that extend respectively through the selected ones of the outer positioning holes 314 to engage respectively and threadably the inner positioning holes 321. The second preferred embodiment has the same advantages as those of the first preferred embodiment.

When it is desired to adjust the width of the Venetian blind 300, the screws 34 are removed from the inner positioning holes 321 and the selected ones of the outer positioning holes 314, and the first head rail 31 is moved relative to the second head rail 32 in the horizontal direction (X) to a desired position. Subsequently, the screws 34 are engaged into the inner positioning holes 321 and two of the outer positioning holes 314 corresponding to the desired position.

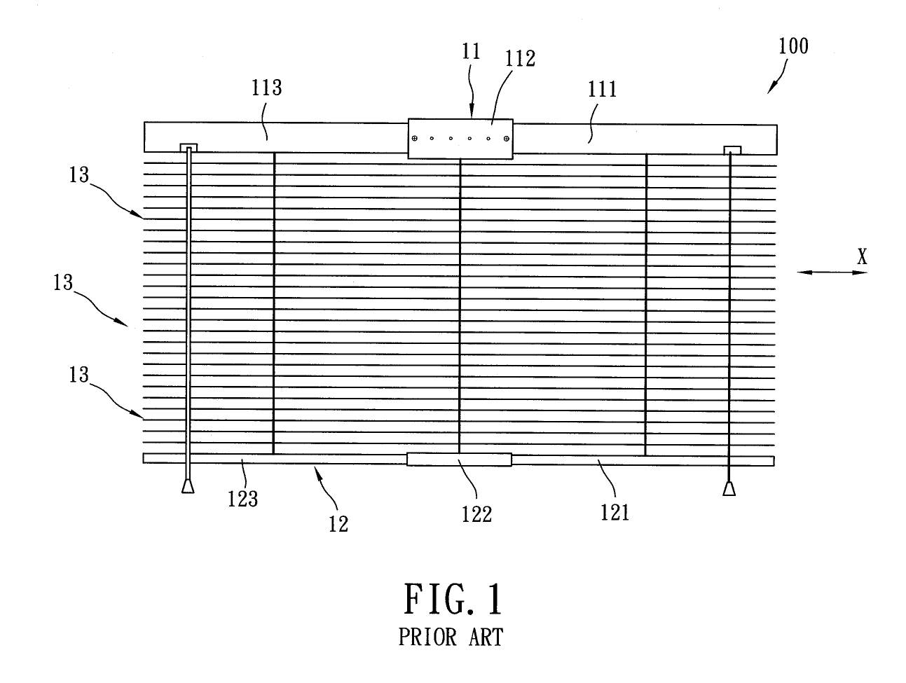

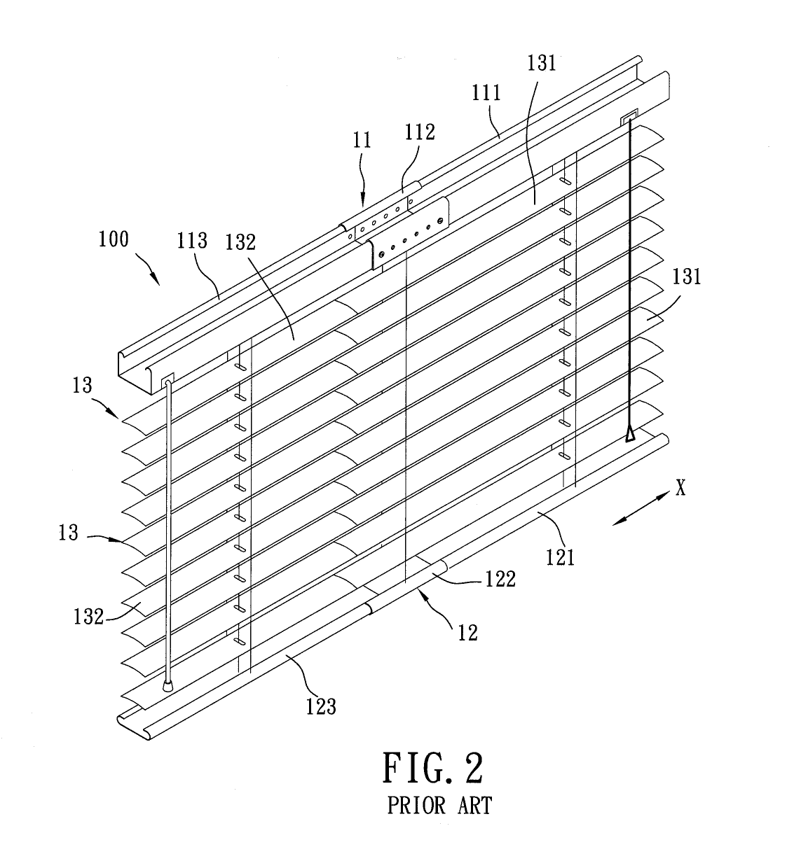

To sum up, the advantages of the adjustable Venetian blind 300 according to the present invention are as follows. In the present invention, the adjustment of the head rail unit 3 and the bottom rail unit 5 is simple as compared to that of the prior art shown in FIGS. 1 and 2. Furthermore, each of the head and bottom rail units 3, 5 is comprised of only two segments, which costs less and is easier to construct than the conventional Venetian blind 100.

While the invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An adjustable Venetian blind comprising:
a head rail unit extending along a horizontal direction, and including a first head rail having an engaging end, a second head rail connected telescopically to said engaging end of said first head rail, and a positioning member locking releasably said first head rail to said second head rail;
a slat unit having
two first ladder cords suspended respectively from two opposite ends of said first head rail,
a second ladder cord suspended from said second head rail,
a plurality of horizontal slats vertically spaced apart from each other and interconnected by said first and second ladder cords, each of said slats having a first slat segment that is connected to said first ladder cords, and a second slat segment that is connected to said second ladder cord and that has an end portion superposed on an end portion of said first slat segment, and
first and second lift cords hung respectively under said first head rail and said second head rail and disposed for lifting said slats; and
a bottom rail unit including a first bottom rail fastened to bottom ends of said first ladder cords, and a second bottom rail connected telescopically to said first bottom rail and fastened to a bottom end of said second ladder cord.

2. The adjustable Venetian blind as claimed in claim 1, wherein said first head rail of said head rail unit has a base rail wall extending along the horizontal direction, two side rail walls extending respectively and upwardly from two opposite sides of said base rail wall, and two guiding walls each extending from an upper end of a respective one of said side rail walls toward the other one of said side rail walls and having a hook-shaped cross-section, said second head rail extending into a space among said base rail wall, said side rail walls, and said guiding walls and being movable relative to said first head rail in the horizontal direction.

3. The adjustable Venetian blind as claimed in claim 2, wherein at least one of said side rail walls of said first head rail is formed with a horizontal row of spaced apart outer positioning holes that are formed in said engaging end of said first head rail, said second head rail being formed with an inner positioning hole, said positioning member extending through said inner positioning hole and a selected one of said outer positioning holes.

4. The adjustable Venetian blind as claimed in claim 3, wherein said positioning member of said head rail unit is a screw extending through the selected one of said outer positioning holes to engage threadably said inner positioning hole.

5. The adjustable Venetian blind as claimed in claim 3, wherein said positioning member of said head rail unit includes a spring plate that is disposed in said second head rail and that has a U-shaped cross-section, and at least one protrusion extending from an end of said spring plate and through said inner positioning hole and the selected one of said outer positioning holes.

6. The adjustable Venetian blind as claimed in claim 3, wherein said first head rail is longer than said second head rail, said first slat segments of said slats being longer than said second slat segments of said slats, said first bottom rail being longer than said second bottom rail.
